(19) United States
(12) Patent Application Publication
(10) Pub. No.: US 2010/0280866 A1
(43) Pub. Date: Nov. 4, 2010

(54) APPARATUS AND METHOD FOR PROVIDING UGC INCLUDING ADVERTISEMENT

(76) Inventors: Sung Hyun Moon, Seoul (KR); Mi Sun Jung, Seoul (KR); Song Jun Lim, Seoul (KR)

Correspondence Address: KANG INTELLECTUAL PROPERTY LAW, LLC, 214 ELM STREET, SUITE 106, WASHINGTON, MO, 63090, US

(21) Appl. No.: 12/434,023

(22) Filed: May 1, 2009

(51) Int. Cl. G06Q 30/00; G06Q 10/00; G06Q 50/00

(52) U.S. Cl. 705/8; 705/400; 705/26; 705/30; 705/14.48

(57) ABSTRACT

An apparatus for providing UGC including a UGC manager storing UGC provided from UGC creators and making a list of UGC provided, an advertisement manager receiving advertisements and advertising information from sponsors attempting to combine an advertisement to a specific UGC, making a list of advertisements and advertising information, and providing the list of advertisements and advertising information to the UGC creators, a UGC provider inserting an advertisement selected by the UGC creator into the UGC, removing the advertisement from the UGC when a total advertising budget is exhausted or in response to a request from a sponsor, and providing the UGC to a user in response to a request from the user, and an advertisement exposure calculator calculating an advertising price by counting mere exposure and click-through exposure of the advertisement combined to the UGC.

### BACKGROUND OF THE INVENTION

1. Field of the Invention

The present invention relates to an apparatus and method for managing User-Generated Content (UGC), which is networked with computers of sponsors, UGC creators, and UGC users, and receives advertisements from the sponsors, receives UGC from UGC creators, and transmits an advertisement on a UGC via streaming to a UGC user by inserting the advertisement into image data of the UGC in response to a request from the UGC user. More particularly, when a UGC creator selects an advertisement to be inserted into a UGC in response to proposals from sponsors, the advertisement is inserted into the UGC and is provided on the UGC to UGC users, and a predetermined rate of compensation is paid to the UGC creator according to the number of exposure of the advertisement by the UGC users. This as a result can motivate the general public to create UGC to activate creation while protecting the copy right of individual's creations by distributing a profit obtained through advertising. In addition, the sponsors can more effectively advertise their products using the UGC created by the general public.

2. Description of the Related Art

User Generated Content (UGC) refers to various kinds of products generated and distributed over the Internet by Internet users. Among these products, multimedia data is considered to be most popular.

Major creators of UGC who are paid for UGC have been experts. UGC created by the general public greatly differs in completeness and quality from that created by the experts. However, if a system for compensating for UGC created by the general public can be established, the general public can be motivated to create UGC, thereby making more efforts to create high-quality UGC dynamic images. This as a result can raise the entire quality of UGC products.

A prior art related to the invention is disclosed in Korean Patent No. 10-0587763. The prior art relates to a method for providing a multimedia file to which an advertisement is combined over the Internet. Specifically, the method provides a multimedia file such as music and images to a user by combining an advertisement file to the multimedia file, so that the user plays the advertisement file along with the multimedia file. As a result, the user can download the multimedia file freely or at a low price, and a sponsor can carry out effective advertising.

Since the advertisement file consists of sounds, texts and images, advertising can be carried out when the multimedia file is being downloaded as well as being played. Although the prior art has proposed a method of inserting advertisements into multimedia files, analyzing user propensity, and selectively exposing a related advertisement, it fails to propose a method of motivating the general public to create UGC by affording compensation unlike the invention.

In addition, the prior art does not propose a method of preventing sponsors from unnecessarily paying an advertising price due to random exposure of an advertisement. In the case of an advertisement, for example, a banner exposed on a web page, even if the advertisement is exposed, the sponsor does not pay the advertising price unless a user access homepage by clicking the banner. In the case of dynamic images, a consumer watches an advertisement inserted into the dynamic images irrespective of his/her selection. Accordingly, one-sided advertising exposure is made on UGC, and the sponsor has to pay the advertising price for the exposure. As a result, a more advertising price may be unnecessarily paid if UGC is watched more.

A more serious problem is that the sponsor cannot make a choice based on the quality of UGC. For example, when a company is also expecting an effect of improving its image, an opposite effect can be made from the advertisement inserted into vulgar UGC. The sponsor wants to insert the advertisement if possible, into UGC the concept of which is consistent with the subject of the advertisement.

In addition, it is important for UGC creators to have a right to select an advertisement to be inserted into UGC so that more UGC can be provided to users and thereby enough compensation can be achieved.

### SUMMARY OF THE INVENTION

The present invention has been made to solve the foregoing problems with the prior art, and an object of the present invention is to provide User-Generated Content (UGC) created by the general public, insert an advertisement selected by a UGC creator through bidding of sponsors into a UGC, and afford a suitable amount of compensation to the UGC creator according to the number of exposure of the advertisement through the UGC to users. This as a result can activate UGC creation by affording compensation to the UGC creator while protecting the copy right of individual's creations. In addition, the sponsors can more effectively advertise their products using the UGC created by the general public.

In accordance with one aspect of the invention, the apparatus for providing UGC may include a UGC manager storing UGC provided from UGC creators and making a list of the provided UGC; an advertisement manager receiving advertisements and advertising information from sponsors each attempting to combine an advertisement to a specific UGC in the UGC list, making a list of advertisements and advertising information, and providing the list of advertisements and advertising information to the UGC creators of the UGC, wherein the advertising information includes a bidding price divided into a mere exposure bidding price and a click-through exposure bidding price and a total advertising budget; a UGC provider inserting an advertisement selected by the UGC creator into the UGC, removing the advertisement from the UGC when the total advertising budget is exhausted or in response to a request from a sponsor of the advertisement, and providing the UGC to a user in response to a request from the user; and an advertisement exposure calculator calculating an advertising price by counting mere exposure and click-through exposure of the advertisement, which is combined to the UGC.

In accordance with another aspect of the invention, the apparatus for providing UGC may include a UGC manager storing, when UGC creators provide UGC by designating the UGC with a field, the UGC provided by classifying the UGC according to the field; an advertisement manager storing, when sponsors provide advertisements and advertising information including a total advertising budget, the advertisements and the advertising information by classifying the advertisements and the advertising information according to a field; a UGC provider collectively inserting an advertisement into a UGC, the field of which matches the field of the advertisement, removing the advertisement from the UGC when a total advertising budget is exhausted or in response to a request from a sponsor of the advertisement, and providing the UGC to a user in response to a request from the user; and an advertisement exposure calculator calculating an advertising price in accordance with a predetermined reference advertising price by counting mere exposure and click-through exposure of the advertisement, which is combined to the UGC.

In the apparatus for providing UGC of the invention, the UGC provider may insert the advertisement into a plurality of positions of the UGC, or limit streaming of the advertisement when the user selects to skip playing part of the advertisement inserted into the plurality of positions.

The apparatus for providing UGC of the invention may further include notification means for inquiring the corresponding sponsor whether or not to replenish an advertising budget when the total advertising budget is exhausted under a predetermined level, and notifying the UGC creator of the advertising information list proposed by the sponsors when it is provided.

The apparatus for providing UGC of the invention may further include an advertising subscriber making, when the UGC creator selects two or more of the advertisements to be inserted by designating the selected advertisements with a sequence, a reservation for one or more of the selected advertisements to be inserted later according to the sequence.

In addition, the apparatus for providing UGC of the invention may further include an advertising subscriber making a reservation for one or more of the advertisements to be inserted into the UGC according to a sequence by which the advertisements are provided, wherein the field of the advertisements is consistent with that of the UGC.

In accordance with a further aspect of the invention, the method for providing UGC may include registering UGC provided from UGC creators by arranging the provided UGC in a list; receiving advertisements and advertising information provided from sponsors each attempting to combine an advertisement into a UGC in the list of the registered UGC, the advertising information including a bidding price divided into a mere exposure bidding price and a click-through exposure bidding price and a total advertising budget; providing a list of the provided advertising information to a creator of the UGC; inserting an advertisement in the advertising information list, selected by the UGC creator, into the UGC; and providing the UGC to a user in response to a request from the user.

In the method for providing UGC of the invention, the advertising information list may be arranged according to amounts of proposed bidding prices while matching the subject of the UGC. The method may further include removing the advertisement inserted into the UGC when a total advertising budget is exhausted or in response to a request from a sponsor of the advertisement.

The method for providing UGC of the invention may further include making, when the UGC creator selects two or more of the advertisements to be inserted from the advertising information list by designating the selected advertisements with a sequence, a reservation for one or more of the selected advertisements to be inserted later according to the sequence.

In addition, the method for providing UGC of the invention may further include calculating an advertising price based on a bidding price corresponding to exposure information proposed by the sponsor by counting mere exposure and click-through exposure of the advertisement, deducing the advertising price from a total advertising budget of the advertisement, and paying the advertising price on an account of the UGC creator.

According to embodiments of the invention. UGC are provided from the general public, advertisements are provided from sponsors, and a UGC is inserted into an advertisement according to predetermined conditions. Specifically, the sponsors propose a variety of bidding prices by selecting a UGC matching their advertising concept, the UGC creator selects an advertisement to be inserted his/her UGC in consideration of the bidding price or the subject of the advertisement, and the selected advertisement is inserted into the UGC. Alternatively, the advertisements can be collectively inserted into UGC in consideration of the field or sequence of the UGC. Then, the advertisement is provided on the UGC to users to play the UGC. When the advertisement is exposed to the users during playing the UGC, compensation is afforded to the UGC creator by calculating the number of exposure of the advertisement. This as a result can activate UGC creation by affording compensation to the UGC creator while protecting the copy right of individual's creations. In addition, the sponsors can more effectively advertise their products.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a network in which an apparatus of providing UGC in accordance with the invention, a user, a sponsor, and a UGC creator terminal are connected with each other;

FIG. 2 illustrates the construction of the apparatus of providing UGC in accordance with the invention;

FIG. 3 illustrates UGC dynamic images into which an advertisement is inserted; and

FIG. 4 is a flowchart illustrating a method of providing UGC in accordance with the invention.

### DETAILED DESCRIPTION OF THE PREFERRED EMBODIMENT

An apparatus of providing UGC in accordance with the present invention will now be described more fully hereinafter with reference to the accompanying drawings.

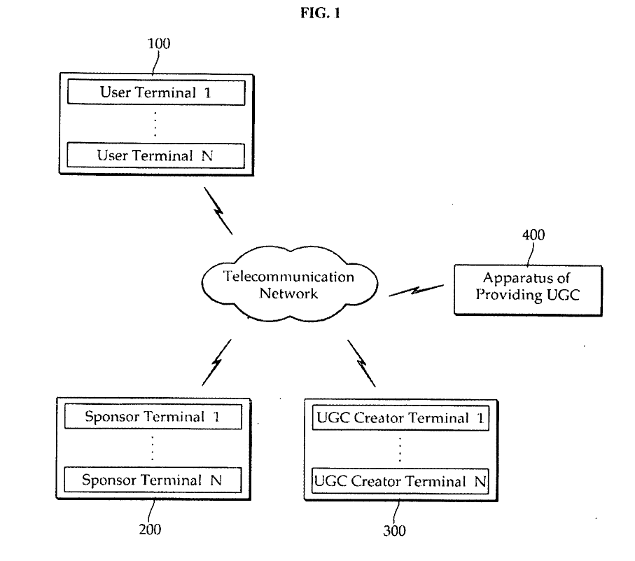

FIG. 1 illustrates a system in which an apparatus of providing User Generated Content (UGC) 400 in accordance with the invention, a user terminal 100, a sponsor terminal 200 and a UGC creator terminal 300 are networked with each other.

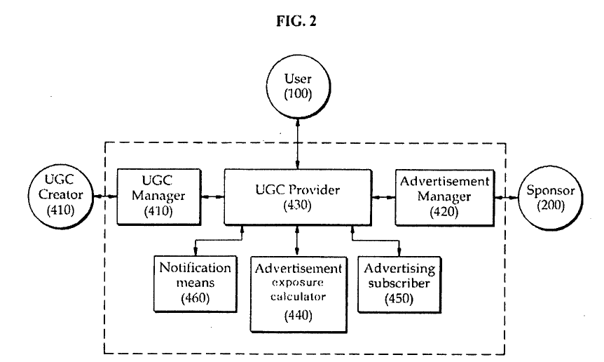

FIG. 2 illustrates the apparatus of providing UGC having an advertisement inserted thereto in accordance with the invention. As shown in FIG. 2, the apparatus of providing UGC 400 in accordance with a first embodiment of the invention includes a UGC manager 410, an advertisement manager 420, a UGC provider 430 and an advertisement exposure calculator 440. The UGC manager 410 stores UGC provided from UGC creators, and makes a list of the UGC. The advertisement manager 420, to which a variety of advertisements and related advertising information are received from sponsors who want to insert an advertisement into a specific UGC in the list of the UGC, makes a list of the advertisements and the advertising information, and provides the list to the UGC creator. The advertising information includes a bidding price divided into a mere exposure bidding price and a click-through exposure bidding price, and a total advertising budget. The UGC provider 430 inserts an advertisement selected by the UGC creator to the UGC, removes the advertisement from the UGC when the total advertisement budge is exhausted or in response to a request from the sponsor of the advertisement, and provides the UGC to a user in response to a request from the user. The advertisement exposure calculator 440 calculates an advertising price by counting a mere exposure frequency and a click-through frequency of the advertisement combined to the UGC.

The UGC manager 410 stores the UGC provided from the UGC creators, and makes a list of the UGC. The list to be provided can be made according to the sequence by which the UGC are provided, or be classified according to the subject of the UGC. In the case of classifying the UGC according to the subject, the UGC creators are required to classify the UGC by considering the subject of the UGC created by the creators and selecting the field of each UGC while providing the UGC. The UGC provided by the UGC creators as above are set into a list, which is in turn provided to the sponsors.

The advertisement manager 420 manages the advertising information about the advertisements of the sponsors. A respective sponsor searches the provided UGC to find a specific UGC, into which he/she wants to insert an advertisement. When a UGC is found, the sponsor inputs the advertisement together with advertising information including a bidding price and a total advertising budge. The advertisement manager 420 makes a list based on proposals from a plurality of the sponsors, and provides the list to a corresponding UGC creator.

Since various kinds of UGC are provided, it is possible to expose an advertisement very effectively by finding a UGC matching the content of the advertisement, for example, sportswear can be very effectively advertised on a UGC that displays the know-how of body building. Thus, the sponsors can select a specific UGC which they want to bid considering the subject of the UGC and the content of the advertisement.

The bidding price is divided into a mere exposure bidding price and a click-through bidding price. The mere exposure bidding price and the click-through bidding price are divided according to the degree of exposure of the advertisement. Specifically, when a consumer watches a UGC into which the advertisement is inserted, the advertisement is exposed to the consumer. This is a characteristic of conventional multimedia advertisements using for example a TV, cable and radio.

In the case of two-way communication such as the Internet, a consumer interested in the advertisement may want to get more information of the advertisement. The consumer then may access more detailed guidance materials such as a homepage of the advertisement by clicking the advertisement on the UGC.

A representative one is to access the homepage of the advertisement by clicking the advertisement published on a web page. That is, the mere exposure bidding price is an advertising price to be paid when the UGC is streamed and thus the advertisement inserted into the UGC is also streamed to consumers. The click-through exposure price is an advertising price to be paid when users access the homepage of the advertisement by clicking the advertisement. Accordingly, when the exposed advertisement is clicked through, not only the mere exposure bidding price but also the click-through bidding price is paid.

The click-through bidding price can be fixed to a predetermined ratio of the mere exposure bidding price, or be set by the sponsor. However, the click-through bidding price can be preferably fixed to a predetermined rate so as to greatly differ from the mere exposure bidding price. This is because it can be evaluated that the users who clicked the advertisement have expressed a particular interest in the advertisement and thereby a higher advertising effect has been achieved.

The total advertising budget is a total amount of advertising price that a sponsor is willing to pay for an advertisement. An amount of money corresponding to the bidding price is reduced whenever the advertisement inserted into the UGC is exposed, and increases whenever the sponsor replenishes the advertising budget. In this case, it is possible to insert an alarm function of notifying the sponsor that the total advertisement budge has dropped under a predetermined level so that the sponsor can replenish the advertisement budge.

The UGC provider 430 inserts and removes an advertisement into and from a UGC, and provides users with the UGC into which the advertisement is inserted. When the UGC creator selects an advertisement to be inserted into a UGC based on the advertising information provided from the advertisement manager 420, the UGC provider 430 inserts the advertisement into the UGC. The UGC provider 430 removes the advertisement in response to a request from the sponsor of the advertisement or when a total advertising budge is exhausted. In addition, the UGC provider 430 provides a user with the UGC, into which the advertisement is inserted, in response to a request from a user.

In addition, the UGC provider 430 can insert the advertisement into a plurality of positions 332 in a UGC data 331. If the UGC has a story including introduction, development, turn and conclusion, the advertisement can be inserted into a pause prior to the conclusion. This can be a method of alleviating consumers from annoyance caused by the exposure of advertisements.

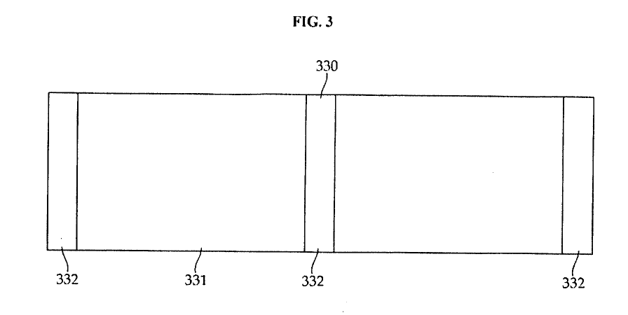

FIG. 3 illustrates a stream of UGC dynamic images and an inserted advertisement. As shown in FIG. 3, a UGC multimedia stream 330 includes a plurality of UGC multimedia data 331 and an advertisement inserted into the positions 332 between the UGC multimedia data 331.

The advertisement can be inserted into several positions of the UGC such as front, rear and middle parts. While one advertisement is generally inserted, a plurality of advertisements can also be inserted. For example, when the UGC is designed to play for a long time, several advertisements can be inserted with suitable time intervals. Furthermore, both advertisements for Ramen (i.e., instant noodle) and egg can be inserted into a UGC displaying the know-how of deliciously cooking Ramen.

In the case where a user repeatedly watches the UGC according to the positions 332 into which an advertisement is inserted, an advertisement skip algorithm can be used to limit the number of displaying the advertisement. For example, after the advertisement inserted into UGC is played once, a user is allowed to skip the advertisement when he/she does not want to watch twice. This as a result can solve an inconvenience of users to watch an advertisement inserted into the UGC whenever playing the UGC. However, an advertisement inserted into the last part of the UGC is set to be repeatedly displayed whenever the UGC is played.

This is because the degree of exposure of the advertisement is divided into mere exposure and click-through. When the user is interested in the advertisement which he/she saw before while repeating the UGC twice or more, he/she can have an opportunity to click the advertisement in order to get detailed information about the advertisement when it is displayed after all UGC dynamic images are provided.

The advertisement exposure calculator 440 calculates an advertising price by counting the mere exposure and the click-through exposure of the advertisement combined to the UGC. Since the mere exposure and the click-through exposure have different bidding prices, an amount of advertising price per click is calculated according to the bidding price proposed by the sponsor and is deducted from the total advertising budget of the sponsor. The deducted amount is then paid to the UGC creator.

An advertising subscriber 450 is also provided. When the UGC creator selects two or more of the advertisements from the list by designating the selected advertisements with a sequence, the advertising subscriber 450 makes a reservation for one or more subsequent advertisements to be inserted later.

For example, when sponsors A, B, C, D and E proposed different bidding prices, the UGC creator can select an advertisement of a sponsor (e.g., the sponsor B) to be inserted at first, and then set reservations for some of advertisements according to the sequence which their sponsors want to be inserted after the first advertisement. In this case, the UGC creator may select an advertisement of a sponsor A as a second and an advertisement of a sponsor D as a third, but reject advertisements of sponsors C and E since bidding conditions or advertising contents are not satisfactory. Then, the advertisements of the sponsors A and D are reserved according to the sequence. When a total advertising budget of the advertisement B is exhausted or an advertisement insertion contract is expired due to other circumstances, the reserved advertisements are inserted into the UGC according to the sequence of the reservation.

When the total advertising budget is exhausted, the UGC provider 430 provides the UGC by removing the advertisement from and inserting the reserved advertisement into the UGC. In this case, further provided is notification means 460 for providing a notification message inquiring the sponsor whether or not to additionally replenish the advertising budget.

In addition, when advertisements and advertising information are provided from the advertisement manager 420 as the sponsors have made a bid, the notification means 460 also provides a message notifying the UGC creator that advertising information has been provided so that the UGC creator can select an advertisement to be inserted.

In accordance with a second embodiment of the invention, a process is collectively carried out according to predetermined conditions unlike the foregoing embodiment, in which sponsors firstly select a UGC and a list of advertisements and advertising information of the sponsors are provided to a UGC creator to determine an advertisement to insert into the UGC.

Specifically, UGC creators select the field of UGC while providing the UGC, and sponsors select the field of their advertisements. Then, the UGC provider 430 collectively inserts the advertisements according to predetermined conditions by matching the field of the advertisements with that of the UGC. In this case, the sponsors do not propose a bidding price per click, but a predetermined reference price is set based on mere exposure and click-through exposure and thereby a bidding price is deducted.

The construction in accordance with the second embodiment of the invention may include a UGC manager, an advertisement manager, a UGC provider and an advertisement exposure calculator. The UGC manager stores the UGC provided by classifying the UGC according to the field when UGC creators provide the UGC by designating the UGC with a field. The advertisement manager stores advertisements and advertising information including a total advertisement budge according to the field when sponsors provide the advertisements and the advertising information by designating the advertisements with the field. The UGC provider collectively inserts each of the advertisements into a respective UGC according to the subject, removes the advertisement from the UGC when a total advertisement budge is exhausted or in response to a request from the sponsor, and provides the UGC in response to a request from a user. The advertisement exposure calculator calculates an advertising price based on a predetermined reference advertising price by counting mere exposure and click-through exposure of the advertisement combined with the UGC whenever the advertisement is exposed to the user.

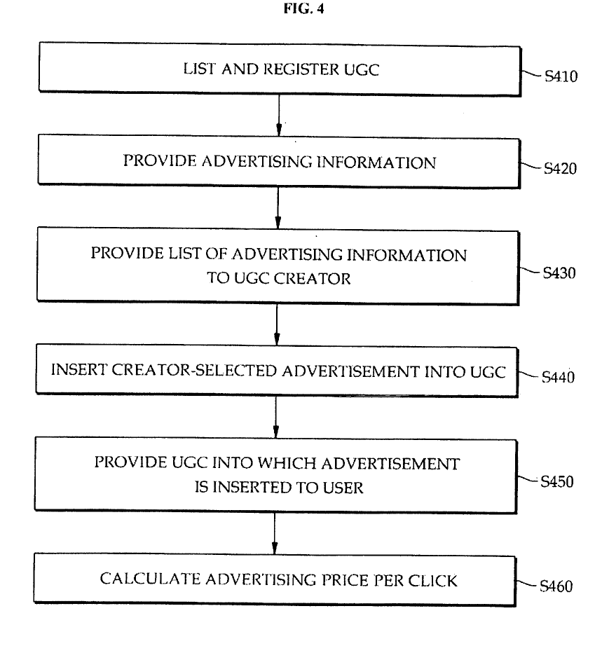

FIG. 4 is a flowchart illustrating a method of providing UGC into which an advertisement is inserted in accordance with the invention. Referring to FIG. 4, in the method of providing UGC in accordance with the invention, when UGC generated by UGC creators are provided, the UGC are registered by making a list of the UGC in S410. The UGC generated and provided by the UGC creators can be arranged in the list according to the sequence or subject so that sponsors can easily search the list for an intended UGC.

Then, each of the sponsors selects a UGC to be combined with an advertisement, and proposes advertisement information in S420. The advertisement information includes a bidding price, divided into a mere exposure bidding price and a click-through exposure bidding price, and a total advertising budget. The sponsor provides a bidding price per click together with the advertisement and the total advertising budget by selecting a UGC, which is determined to have a high advertising effect when combined with the advertisement, from the registered UGC.

In subsequence, the adverting information on which the bidding price and the like are proposed is arranged into a list, which is in turn provided to a UGC creator in S430. The advertising information proposed according to various conditions of the sponsors is provided to the UGC creators to select an advertisement. The advertising information list can be provided in the bidding sequence of the advertisements, or can be provided as being arranged according to the sequence of bidding prices.

Next, an advertisement selected from the advertising information list by the UGC creator is inserted into a UGC in S440. The advertisement can be inserted into a plurality of positions, which are selected by the UGC creator or the sponsor in consideration of the subject of the UGC.

Finally, when a user selects the UGC into which the advertisement is inserted, the UGC is provided to the user in S450. Then, an advertising price of the advertisement exposed to the user is calculated by counting mere exposure and click-through exposure in S460. As a total advertising budget is exhausting, the sponsor is notified to determine whether or not to replenish an additional advertising budget. In addition, when the advertising information is provided from the sponsor, the advertising information is notified to the UGC creator so that the UGC creator can select a proposed advertisement based on the advertising information.

As set forth above, the invention enables sponsors to effectively advertise their products by providing users with a UGC into which an advertisement is inserted. In addition, the invention can activate UGC creation by affording compensation to UGC creators while protecting the copy right of the UGC creators by calculating an advertising price by counting click the advertisement.

While the present invention has been described with reference to the particular illustrative embodiments and the accompanying drawings, it is not to be limited thereto. Accordingly, the foregoing embodiments can be suitably modified and altered, and such applications fall within the scope and spirit of the present invention that shall be defined by the appended claims.

What is claimed is:

1. An apparatus for providing user-generated content (UGC) having an advertisement inserted therein comprising:
a UGC manager storing UGC provided from UGC creators and making a list of the UGC provided;
an advertisement manager receiving advertisements and advertising information from sponsors each attempting to combine an advertisement to a specific UGC in the UGC list, making a list of advertisements and the advertising information, and providing the list of advertisements and advertising information to the UGC creators of the UGC, the advertising information including a bidding price divided into a mere exposure bidding price and a click-through exposure bidding price and a total advertising budget;
a UGC provider inserting an advertisement selected by the UGC creator into the UGC, removing the advertisement from the UGC when the total advertising budget is exhausted or in response to a request from a sponsor of the advertisement, and providing the UGC to a user in response to a request from the user; and
an advertisement exposure calculator calculating an advertising price in accordance with an advertising price per click based on a bidding price by counting mere exposure and click-through exposure of the advertisement, which is combined to the UGC.

2. An apparatus for providing user-generated content (UGC) having an advertisement inserted therein comprising:
a UGC manager storing, when UGC creators provide the UGC by designating the UGC with a field, the UGC provided by classifying the UGC according to the field;
an advertisement manager storing, when sponsors provide advertisements and advertising information including a total advertising budget, the advertisements and the advertising information by classifying the advertisements and the advertising information according to a field;
a UGC provider collectively inserting an advertisement into a UGC, the field of which matches the field of the advertisement, removing the advertisement from the UGC when the total advertising budget is exhausted or in response to a request from a sponsor of the advertisement, and providing the UGC to a user in response to a request from the user; and
an advertisement exposure calculator calculating an advertising price based on a predetermined reference advertising price by counting mere exposure and click-through exposure of the advertisement, which is combined to the UGC.

3. The apparatus according to claim 1, wherein the UGC provider inserts the advertisement into a plurality of positions of the UGC.

4. The apparatus according to claim 3, wherein the UGC provider limits streaming of the advertisement when the user selects to skip playing part of the advertisement inserted into the plurality of positions.

5. The apparatus according to claim 1, further comprising notification means for inquiring the sponsor whether or not to replenish an advertising budget when the total advertising budget is exhausted under a predetermined level, and notifying the UGC creator of the advertising information list proposed by the sponsor when it is provided.

6. The apparatus according to claim 1, further comprising an advertising subscriber making, when the UGC creator selects two or more of the advertisements to be inserted by designating the selected advertisements with a sequence, a reservation for one or more of the selected advertisements to be inserted later according to the sequence.

7. The apparatus according to claim 2, further comprising an advertising subscriber making a reservation for one or more of the advertisements to be inserted into the UGC according to a sequence by which the advertisements are provided, wherein the field of the advertisements is consistent with that of the UGC.

8. A method for providing user-generated content (UGC) having an advertisement inserted therein, comprising:
registering UGC provided from UGC creators by arranging the provided UGC in a list;
receiving advertisements and advertising information provided from sponsors each attempting to combine an advertisement into a UGC in the UGC list, the advertising information including a bidding price divided into a mere exposure bidding price and a click-through exposure bidding price and a total advertising budget;
providing a list of advertisements and advertising information to a creator of the UGC;
inserting an advertisement in the list of advertisements and the advertising information, selected by the UGC creator, into the UGC; and
providing the UGC to a user in response to a request from the user.

9. The method according to claim 8, wherein the list of advertisements and advertising information is arranged according to amounts of proposed bidding prices while matching a subject of the UGC.

10. The method according to claim 8, further comprising removing the advertisement inserted into the UGC when a total advertising budget is exhausted or in response to a request from a sponsor of the advertisement.

11. The method according to claim 8, further comprising making, when the UGC creator selects two or more of the advertisements to be inserted from the list of advertisements and advertising information by designating the selected advertisements with a sequence, a reservation for one or more of the selected advertisements to be inserted later according to the sequence.

12. The method according to claim 8, further comprising calculating an advertising price based on a bidding price corresponding to exposure information proposed by the sponsor by counting mere exposure and click-through exposure of the advertisement, deducing the advertising price from a total advertising budget of the advertisement, and paying the advertising price on an account of the UGC creator.

13. The apparatus according to claim 2, wherein the UGC provider inserts the advertisement into a plurality of positions of the UGC.

14. The apparatus according to claim 13, wherein the UGC provider limits streaming of the advertisement when the user selects to skip playing part of the advertisement inserted into the plurality of positions.

15. The apparatus according to claim 2, further comprising notification means for inquiring the sponsor whether or not to replenish an advertising budget when the total advertising budget is exhausted under a predetermined level, and notifying the UGC creator of the advertising information list proposed by the sponsor when it is provided.
